(19) United States
(12) Patent Application Publication
(10) Pub. No.: US 2008/0137600 A1
(43) Pub. Date: Jun. 12, 2008

(54) SYSTEM AND METHOD FOR ALLOCATING WIRELESS RESOURCES IN WIRELESS PERSONAL AREA NETWORK

(76) Inventors: Young Ae JEON, Daejeon (KR); Sang Jae LEE, Daejeon (KR); Sang Sung CHOI, Daejeon (KR); Kwang Roh PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/952,195

(22) Filed: Dec. 7, 2007

(30) Foreign Application Priority Data
Dec. 8, 2006 (KR) 10-2006-0124912

(51) Int. Cl. H04Q 7/00

(52) U.S. Cl. 370/329

(57) ABSTRACT

Provided are a system and a method for allocating wireless resources in a WPAN. The system includes an MAC layer. The MAC layer divides a superframe into a predetermined number of groups, estimates the number of MASs requested by the MAC client and the number of required consecutive MASs, and allows the consecutive MASs to be distributed and allocated for each divided group. With this structure, adjacent clients can use a common MAS and thus a minimum resource is allocated to the adjacent clients in a WPAN.

### CLAIM OF PRIORITY

This application claims the benefit of Korean Patent Application No. 10-2006-124912 filed on Dec. 8, 2006 in the Korean Intellectual Property Office, the disclosure of which is incorporated herein by reference.

### BACKGROUND OF THE INVENTION

1. Field of the Invention

The present invention relates to a method and a system for allocating wireless resources in a wireless personal area network (WPAN), and, more particularly, to a method and a system for allocating wireless resources in a WPAN, capable of allocating minimum resources to an adjacent client using a common medium access slot (MAS) in a distributed WPAN.

This work was supported by the IT R&D program of MIC/IITA[2006-S-071-01, Development of UWB Solution for High Speed Multimedia Transmission].

2. Description of the Related Art

The WPAN is a technology for supporting various services by supporting communication between miniature apparatuses (multimedia) that are easily carried with low power as well as wirelessly connecting audio/video apparatuses existing a relatively short distance of within 10 m, and a computer and peripheral devices.

A media access control (MAC) for the WPAN can be designed in two access methods of a centralized access method and a distributed access method. In the centralized access method, a predetermined device operating by reserving resources in advance through distributed reservation protocol, that is, a coordinator is selected, and a relevant coordinator manages and coordinates media accesses for all devices. On the other hand, in the distributed access method, one or more devices jointly make a reservation of resources through prioritized contention access, and transfer a frame through prioritized contention access. Accordingly, all the devices share a burden of managing a media access of each other.

The above-described distributed access method of the MAC has an advantage that a network is easily formed in a wireless environment where gathering and parting of devices frequently occur because each device manages network in itself. However, the distributed access method has disadvantages that an amount of data analysis regarding adjacent devices increases compared to the centralized access method, and a time consumed for finding out a point of compromise between devices is long and thus resources can be wasted. Particularly, in the distributed access method, not only resources are wasted but also power management is difficult unless the same resource allocating method is shared in the case where resources for control data of MAC devices are allocated with consideration of requirements of respective devices.

Meanwhile, a timing concept called a superframe is used in a WPAN environment.

FIG. 1 is a view illustrating a construction of a general superframe.

Referring to FIG. 1, the superframe includes time slots called MASs and is classified into a beacon period and a data period.

An MAS belonging to the beacon period is used for sending a beacon to respective devices, and include a predetermined information element (IE) field performing negotiation regarding MAS allocation. Also, an MAS belonging to the data period includes a command frame performing negotiation regarding MAS allocation.

Meanwhile, referring to FIG. 1, the superframe structure is divided into MASs of a 256 μs unit, and sixteen MASs constitute one zone.

Hereinafter, an MAS belonging to the beacon period is called a beacon slot, and an MAS belonging to the data period is called a data slot.

FIG. 2 is a view illustrating an example of a WPAN environment according to a general distributed access method.

Referring to FIG. 2, respective devices of a distributed WPAN including a device1 10a, a device2 10b, and a device3 10c send their respective beacons to an adjacent device before data transmission in a beacon period of the superframe structure illustrated in FIG. 1. Here, the device sends a beacon using a beacon slot of beacon slots that is not used within the beacon period. Also, the respective devices allow their beacon frame to be transmitted to include their device identifier (ID), their beacon slot data, and media use data. Arrows drawn with respect to respective devices indicate directions in which beacons of the respective devices are transmitted.

That is, according to the distributed WPAN, all devices constituting the WPAN share necessary data through beacons in order to perform operations such as a channel time reservation and synchronization in cooperation with one another.

Therefore, a plurality of devices in the distributed WPAN distribute Quality of Service (QoS), hibernation mode, and security, and operate them in themselves as well as coordinate a data transmission timing between their adjacent devices by transmitting their beacon frames, respectively, and analyzing beacon frame data of their adjacent devices.

Also, respective devices in the distributed WPAN use a predetermined information element field of a beacon period, or make a reservation of at least one MAS of a data period in advance through negotiation using a command frame of a data period to prevent data transmission contention and collision between the devices upon data transmission.

FIG. 3 is a view illustrating an example of MAS allocation in a general distributed WPAN.

Referring to FIG. 3, a superframe of the distributed WPAN includes sixteen MASs grouped into one zone, and is divided into sixteen regions on the whole.

Under this environment, referring to FIG. 3, devices make a reservation of different MASs, respectively, so that a relevant MAS is allocated on each device.

Meanwhile, it is indispensable that a device in a WPAN uses prioritized contention access (PCA) at the minimum for an indispensable network management and a connection management protocol even when a distributed reservation protocol (DRP) is primarily used in order to transmit data frame while the device guarantees QoS.

In the case where a device uses a PCA in a WPAN, a condition that a transmitting device and a receiving device adjacent to each other should share the same MAS should be satisfied. The reason why the above condition should be satisfied is that a process of transmitting, at a device in the WPAN, data with consideration of an MAS of a counterpart MAS having a different MAS is complicated, and even when an arbitrary transmitting device is selected from competition and obtains an opportunity of transmitting data, there is a tendency that transmitted data is not received in a receiving device having a different MAS due to the complicated process of transmitting the data.

Furthermore, when the WPAN extends an MAS to include an MAS of an adjacent device with consideration of this complicated process, resources may be wasted unnecessarily.

Therefore, a method for increasing an efficiency of resources and simplifying power resource management by allowing adjacent devices to use a common MAS at the minimum for control data of a device in a distributed WPAN is required.

### SUMMARY OF THE INVENTION

The present invention has been made to solve the foregoing problems of the prior art and therefore an object of the present invention is to provide a method and a system for allocating wireless resources, for allowing resource reservation between adjacent devices to be efficiently performed in a WPAN.

According to an aspect of the invention, the invention provides a WPAN system having an MAC client layer including a plurality of MAC clients, the WPAN system including an MAC layer dividing a superframe into a predetermined number of groups, estimating the number of MASs requested by the MAC client and the number of requested consecutive MASs, and allowing the consecutive MASs to be distributed and allocated for each of the divided groups when MAS allocation requests are collected from the MAC client.

The MAC layer groups a predetermined number of MASs into one zone such that the superframe is divided into a predetermined number of zones on the whole, and divides the zones into a predetermined number of groups.

The MAC layer allows the superframe to be divided into sixteen zones, and allows a structure of the superframe divided into the sixteen zones to be divided into a first group including one of the rest zones excluding a zone including a beacon period, a second group including two zones, a third group including four zones, and an fourth group including eight zones.

The MAC layer defines a zone of the divided zones that is included in a beacon period as a zeroth zone, and allows MASs for which an allocation request has been made to be allocated starting from a last MAS of the zeroth zone when the number of the MASs for which the allocation request has been made is less than the number of allocatable MASs excluding a beacon slot in the zeroth zone.

The MAC layer allows MASs for which an allocation request is made by the MAC client to be distributed and allocated from a zone of the first group to a zone of the fourth group depending on the number of the requested consecutive MASs, and the allocation beginning at a first MAS of the corresponding zone when the MASs are to be allocated in other zones excluding the zeroth zone.

The MAC layer allows the MASs for which the allocation request is made by the MAC client to be allocated in other zones excluding the zeroth zone when the number of the allocatable MASs is less than a predetermined set number and the MASs for which the allocation request is made is not allocatable in the zeroth zone, or when MASs to be allocated exist even after the MASs for which the allocation request is made are allocated in the zeroth zone.

The MAC layer includes an MAC application interface block for collecting the MAS allocation request provided from the MAC client; and an MAC resource management block for calculating the number of MASs requested by the MAC client and the number of requested consecutive MASs on the basis of the collected MAS allocation request to allow the consecutive MASs to be distributed and allocated for each of the divided groups.

According to another aspect of the invention for realizing the object, there is provided a method for allocating wireless resources in a WPAN including an MAC client layer having a plurality of MAC clients, and an MAC layer, the method including: dividing, at the MAC layer, a superframe structure into a predetermined number of groups; estimating, at the MAC layer, the number of MASs requested by the MAC client and the number of requested consecutive MASs when an MAS allocation request is collected from the MAC client; and distributing and allocating, at the MAC layer, the estimated consecutive MASs for each of the divided groups.

The dividing, at the MAC layer, of the superframe into the predetermined number of groups includes: grouping a predetermined number of MASs of the superframe as one zone to allow the superframe to be divided into a predetermined number of zones on the whole; and dividing the zones into a predetermined number of groups.

The dividing, at the MAC layer, of the superframe into the predetermined number of groups includes: dividing the superframe into sixteen zones; and dividing the divided zones into a first group including one of the rest zones excluding a zone including a beacon period, a second group including two zones, a third group including four zones, and an fourth group including eight zones.

The distributing and allocating, at the MAC layer, of the estimated consecutive MASs includes: defining a zone of the divided zones that is included in a beacon period as a zeroth zone; and allowing MASs for which an allocation request has been made to be allocated starting from a last MAS of the zeroth zone when the number of the MASs for which the allocation request has been made is less than the number of allocatable MASs excluding a beacon slot in the zeroth zone.

The distributing and allocating, at the MAC layer, of the estimated consecutive MASs includes: distributing and allocating MASs for which an allocation request is made by the MAC client, from a zone of the first group to a zone of the eighth group depending on the number of the requested consecutive MASs when the MASs are to be allocated in other zones excluding the zeroth zone, and beginning to allocate at a first MAS of the corresponding zone.

The MASs for which an allocation request is made by the MAC client are allocated in other zones excluding the zeroth zone when the number of the allocatable MASs is less than a predetermined set number and the MASs for which the allocation request is made are not allocatable in the zeroth zone, or when MASs to be allocated exist even after the MASs for which the allocation request is made are allocated in the zeroth zone.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a general superframe;

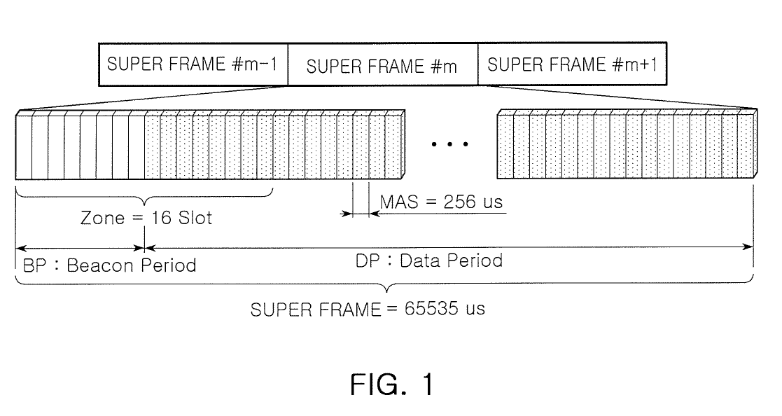

FIG. 2 is a view illustrating an example of a WPAN environment according to a general distributed access method;

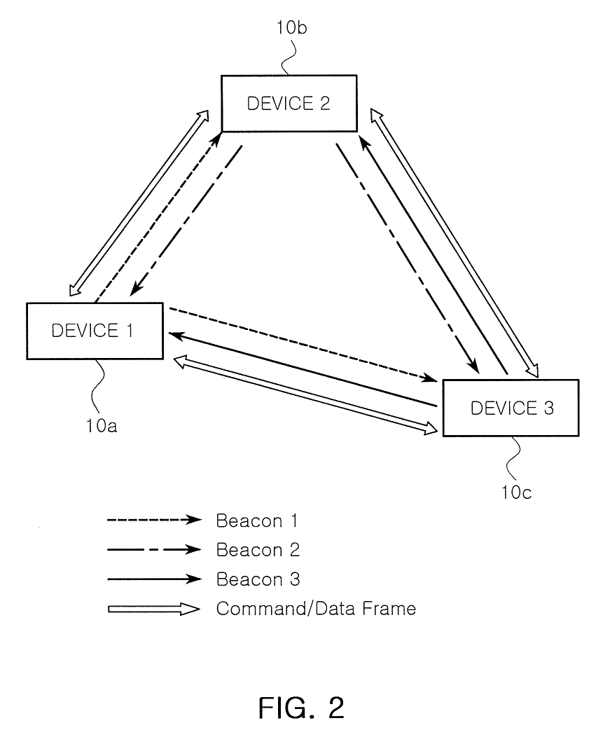

FIG. 3 is a view illustrating an example of MAS allocation in a general distributed WPAN;

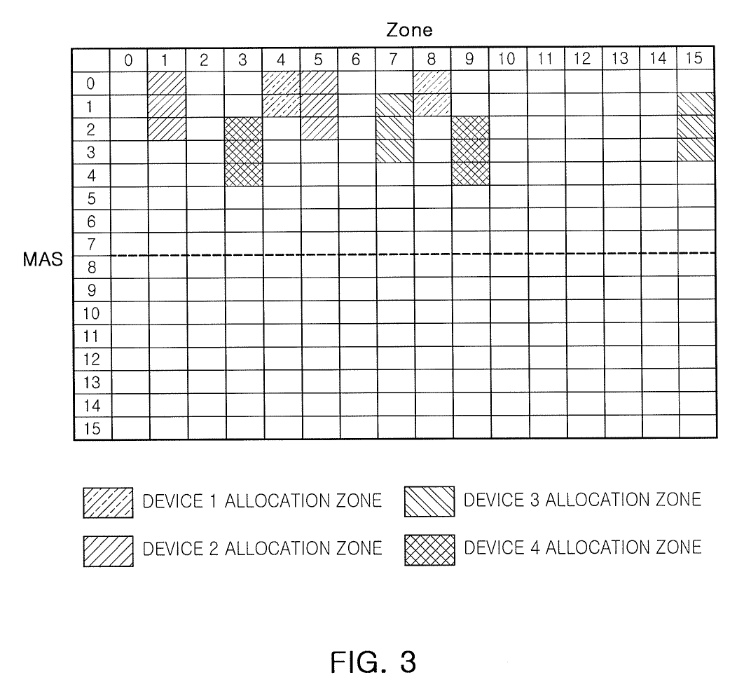

FIG. 4 is a view illustrating a WPAN system according to a preferred embodiment of the present invention;

FIG. 5 is a view illustrating a superframe according to a preferred embodiment of the present invention;

FIG. 6 is a flowchart of a method for allocating resources in a distributed WPAN according to a preferred embodiment of the present invention; and

FIG. 7 is a view illustrating allocated MAS data of a WPAN according to a preferred embodiment of the present invention.

### DETAILED DESCRIPTION OF THE PREFERRED EMBODIMENT

Certain or exemplary embodiments of the present invention will now be described in detail with reference to the accompanying drawings. However, in description of operation principles associated with the embodiments of the present invention, detailed description of a known art or construction is omitted because it may obscure the spirit of the present invention unnecessarily.

Also, like reference numerals refer to like elements throughout the specification.

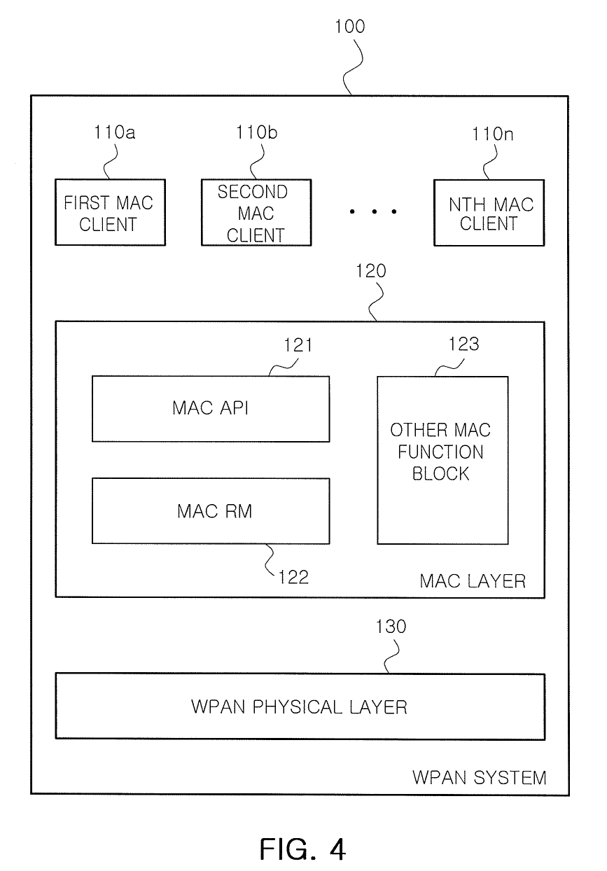

FIG. 4 is a view illustrating a WPAN system according to a preferred embodiment of the present invention.

Referring to FIG. 4, the WPAN can include, from an upper ranking end, a media access control client layer including a plurality of media access control (MAC) client 110, an MAC layer 120, and a physical layer 130. The MAC layer 120 can include an MAC application interface block (API) 121, an MAC resource management (RM) block 122, and other MAC block 123.

In the WPAN system, each MAC client 110 requests the MAC API 121 of the MAC layer 120 to be sent an MAS required for network control and connection management protocol.

Also, the WPAN system receives resource allocation data requested by the MAC client 110 through the MAC API 121 of the MAC layer 120, and allocates necessary resources to the MAC client 110 through the MAC RM 122 so that corresponding allocated data can be provided to the MAC client 110.

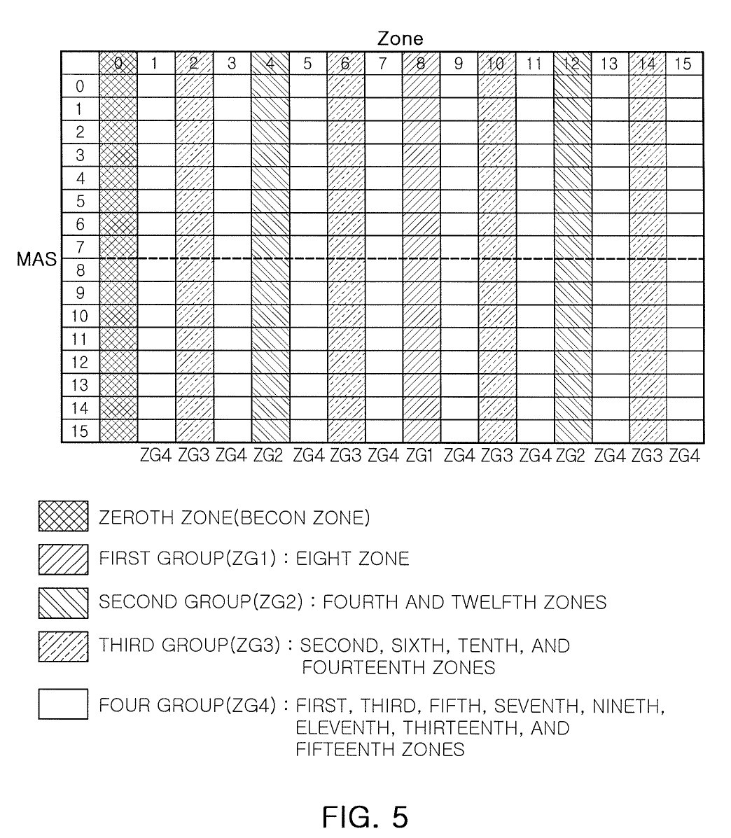

Meanwhile, the WPAN system can divide a structure of the superframe as illustrated in FIG. 5 before the MAC layer 120 allocates resources to the MAC client 110.

FIG. 5 is a view illustrating a structure of superframe according to a preferred embodiment of the present invention.

Referring to FIG. 5, the MAC layer 120 of the WPAN is formed such that an entire length of the superframe is divided into MASs of a 256 μs unit, sixteen MASs are grouped as one zone to allow the superframe to be divided into sixteen zones on the whole.

Referring to FIG. 5, the MAC layer 120 that has divided the superframe into sixteen zones gives zone numbers of 0-15 to respective zones starting from a left side to a right side, and vertically gives MAS numbers of 0-15 to MASs contained in each zone starting from an upper side to a lower side.

Also, the MAC layer 120 divides rest zones excluding a beacon zone, which is a zeroth zone, into a predetermined number of groups and manages the same. FIG. 5 illustrates the MAC layer 120 divides the rest zones into four groups and manages the same.

At this point, the MAC layer 120 can allow a first group to include an eighth zone, a second group to include a fourth zone and a twelve zone, a third group to include a second zone, a sixth zone, a tenth zone, and a fourteenth zone, a fourth group to include a first zone, a third zone, a fifth zone, a seventh zone, a ninth zone, an eleventh zone, a thirteenth zone, and a fifteenth zone.

Next, a method for allocating resources at the MAC layer 120 having a structure of the above-described superframe will be described in detail.

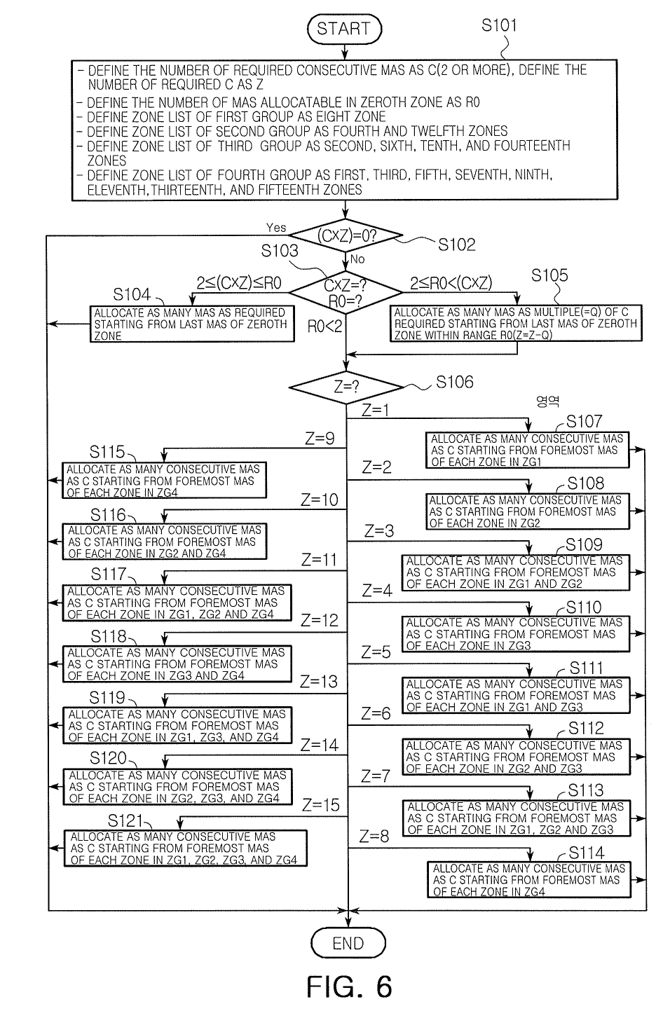

FIG. 6 is a flowchart of a method for allocating resources in a distributed WPAN according to a preferred embodiment of the present invention.

Particularly, FIG. 6 illustrates a method for allocating, at the MAC layer 120, MASs for which an allocation request is made by the MAC client 110.

Referring to FIG. 6, the MAC layer 120 can designate the number of consecutive MASs requested by the MAC client 110 as ‘C’ and define the requested number C as ‘Z’ before MAS allocation (S101). That is, for example, in the case where the MAC client 110 requests allocation of fifteen MASs and the number of consecutive MASs is three, C can be 3 and Z can be 5. Also, for example, the MAC layer 120 can define the number of allocatable MASs excluding a beacon slot used in a zeroth zone as ‘R0’, and define a zone list of each group (S101) From this, the MAC RM 122 of the MAC layer 120 multiplies C by Z to judge whether a corresponding result is zero (S102). When the corresponding result is zero as a result of the judgment, the MAC RM 122 ends an MAS providing process. When the corresponding result is not zero as a result of the judgment, the MAC RM 122 allocates the MASs requested by the MAC client 110 using the MAC API 121 according to the following condition.

First, the MAC RM 122 checks a result value obtained by multiplying C by Z and R0 (S103). When the result value obtained by multiplying C by Z is 2 or more and less than R0, the MAC RM 122 allocates as many MASs as the number requested by the MAC client 110 sequentially starting from a last MAS of a zeroth zone, that is, a fifteenth MAS, and provides the MASs to the corresponding MAS client 110 (S104).

The MAC RM 122 performs MAS allocation according to conditions below in the case where the result value obtained by multiplying C by Z is 2 or more but greater than R0, or in the case where R0 is less than 2 (S106).

Before S106, when the result value obtained by multiplying C by Z is less than 2, the MAC RM 122 allocates as many MASs as the number allocatable in the zeroth zone (S105), and allocates MASs corresponding to the number obtained by subtracting an allocation number of the zeroth zone from the result value obtained by multiplying C by Z depending on the following condition.

First, when the number of zones required for allocating MASs is 1, the MAC RM 122 allocates as many MASs as consecutive C in a zone included in the first group (S107). Here, the MAC RM 122 performs allocation on a foremost MAS in a relevant zone. That is, the MAC RM 122 allocates as many MASs as required C starting from a zeroth MAS in the eighth zone of the first group.

When the number of zones required for allocating MASs is 2, the MAC RM 122 allocates as many MASs as consecutive C in a zone included in the second group (S108). That is, the MAC API 121 allocates as many MASs as required C starting from the zeroth MAS in each of the fourth zone and the twelfth zone in the second group.

When the number of zones required for allocating MASs is 3, the MAC RM 122 allocates as many MASs as consecutive C in a zone included in the first and second groups (S109). That is, the MAC API 121 allocates as many MASs as required C starting from the zeroth MAS in each of the fourth, eighth, and twelfth zones.

When the number of zones required for allocating MASs is 4, the MAC RM 122 allocates as many MASs as consecutive C in a zone included in the third group (S110). That is, the MAC API 121 allocates as many MASs as required C starting from the zeroth MAS in each of the second, sixth, tenth, and fourteenth zones in the third group.

When the number of zones required for allocating MASs is 5, the MAC RM 122 allocates as many MASs as consecutive C in a zone included in the first and third groups (S111). That is, the MAC API 121 allocates as many MASs as required C starting from the zeroth MAS in each of the second, sixth, eighth, tenth, and fourteenth zones.

When the number of zones required for allocating MASs is 6, the MAC RM 122 allocates as many MASs as consecutive C in a zone included in the second and third groups (S112). That is, the MAC API 121 allocates as many MASs as required C starting from the zeroth MAS in each of the second, fourth, sixth, tenth, twelfth and fourteenth zones.

When the number of zones required for allocating MASs is 7, the MAC RM 122 allocates as many MASs as consecutive C in a zone included in the first, second, and third groups (S113). That is, the MAC API 121 allocates as many MASs as required C starting from the zeroth MAS in each of the second, fourth, sixth, eighth, tenth, twelfth and fourteenth zones.

When the number of zones required for allocating MASs is 8, the MAC RM 122 allocates as many MASs as consecutive C in a zone included in the fourth group (S114). That is, the MAC API 121 allocates as many MASs as required C starting from the zeroth MAS in each of the first, third, fifth, seventh, ninth, eleventh, and thirteenth zones in the fourth group.

When the number of zones required for allocating MASs is 9, the MAC RM 122 allocates as many MASs as consecutive C in a zone included in the first and third groups (S115). That is, the MAC API 121 allocates as many MASs as required C starting from the zeroth MAS in each of the first, third, fifth, seventh, eighth, ninth, eleventh, and thirteenth zones.

When the number of zones required for allocating MASs is 10, the MAC RM 122 allocates as many MASs as consecutive C in a zone included in the second and fourth groups (S116). That is, the MAC API 121 allocates as many MASs as required C starting from the zeroth MAS in each of the first, third, fourth, fifth, seventh, ninth, eleventh, twelfth, thirteenth, and fifteenth zones.

When the number of zones required for allocating MASs is 11, the MAC RM 122 allocates as many MASs as consecutive C in a zone included in the second and fourth groups (S117). That is, the MAC API 121 allocates as many MASs as required C starting from the zeroth MAS in each of the first, third, fourth, fifth, seventh, eighth, ninth, eleventh, twelfth, thirteenth, and fifteenth zones.

When the number of zones required for allocating MASs is 12, the MAC RM 122 allocates as many MASs as consecutive C in a zone included in the third and fourth groups (S118). That is, the MAC API 121 allocates as many MASs as required C starting from the zeroth MAS in each of the first, second, third, fifth, sixth, seventh, ninth, tenth, eleventh, thirteenth, fourteenth, and fifteenth zones.

When the number of zones required for allocating MASs is 13, the MAC RM 122 allocates as many MASs as consecutive C in a zone included in the first, third and fourth groups (S119). That is, the MAC API 121 allocates as many MASs as required C starting from the zeroth MAS in each of the first, second, third, fifth, sixth, seventh, eighth, ninth, tenth, eleventh, thirteenth, fourteenth, and fifteenth zones.

When the number of zones required for allocating MASs is 14, the MAC RM 122 allocates as many MASs as consecutive C in a zone included in the second, third and fourth groups (S120). That is, the MAC API 121 allocates as many MASs as required C starting from the zeroth MAS in each of the first, second, third, fourth, fifth, sixth, seventh, ninth, tenth, eleventh, twelfth, thirteenth, fourteenth, and fifteenth zones.

When the number of zones required for allocating MASs is 15, the MAC RM 122 allocates as many MASs as consecutive C in a zone included in the first, second, third and fourth groups (S121). That is, the MAC API 121 allocates as many MASs as required C starting from the zeroth MAS in each of the first, second, third, fourth, fifth, sixth, seventh, eighth, ninth, tenth, eleventh, twelfth, thirteenth, fourteenth, and fifteenth zones.

The MAC layer 120 can save wireless resources while the respective MAC clients 110 transmit data by allowing the same MAS to be allocated to all adjacent MAC clients 110 in a WPAN environment according to the above-described MAS allocation method.

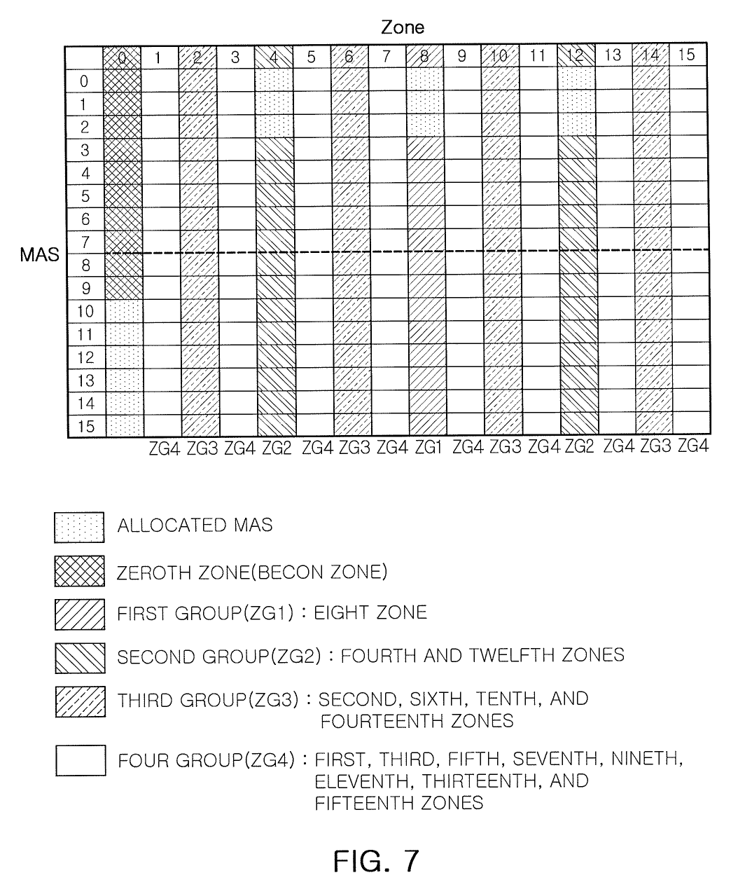

FIG. 7 is a view illustrating allocated MAS data of a WPAN according to a preferred embodiment of the present invention.

FIG. 7 illustrates an example where the number of required consecutive MASs is 3 and the number of required MASs is 15. That is, FIG. 7 illustrates the case where C is 3 and Z is 5 in FIG. 6.

Therefore, the MAC RM 122 of the MAC layer 120 can allocate three MASs starting from a fifteenth MAS two times in the zeroth zone, and allocate the rest nine consecutive MASs to three zones, i.e., the fourth, eighth, and twelfth zones included in the first and second groups.

A system and a method for allocating wireless resources in a WPAN can allow reservation of resources between adjacent clients to be efficiently performed by allowing the same MAS to be allocated to the adjacent MAC clients in a WPAN environment.

While the present invention has been shown and described in connection with the preferred embodiments, it will be apparent to those skilled in the art that modifications and variations can be made without departing from the spirit and scope of the invention as defined by the appended claims.

What is claimed is:

1. A WPAN (wireless personal area network) system having an MAC (media access control) client layer including a plurality of MAC clients, the WPAN system comprising:
an MAC layer dividing a superframe into a predetermined number of groups, estimating the number of MASs (media access slots) requested by the MAC client and the number of requested consecutive MASs, and allowing the consecutive MASs to be distributed and allocated for each of the divided groups when MAS allocation requests are collected from the MAC client.

2. The system according to claim 1, wherein the MAC layer groups a predetermined number of MASs into one zone such that the superframe is divided into a predetermined number of zones on the whole, and divides the zones into a predetermined number of group.

3. The system according to claim 2, wherein the MAC layer allows the superframe to be divided into sixteen zones, and allows a structure of the superframe divided into the sixteen zones to be divided into a first group including one of the rest zones excluding a zone including a beacon period, a second group including two zones, a third group including four zones, and an fourth group including eight zones.

4. The system according to claim 3, wherein the MAC layer defines a zone of the divided zones that is included in a beacon period as a zeroth zone, and allows MASs for which an allocation request has been made to be allocated starting from a last MAS of the zeroth zone when the number of the MASs for which the allocation request has been made is less than the number of allocatable MASs excluding a beacon slot in the zeroth zone.

5. The system according to claim 4, wherein the MAC layer allows MASs for which an allocation request is made by the MAC client to be distributed and allocated from a zone of the first group to a zone of the fourth group depending on the number of the requested consecutive MASs, and the allocation beginning at a first MAS of the corresponding zone when the MASs are to be allocated in other zones excluding the zeroth zone.

6. The system according to claim 5, wherein the MAC layer allows the MASs for which the allocation request is made by the MAC client to be allocated in other zones excluding the zeroth zone when the number of the allocatable MASs is less than a predetermined set number and the MASs for which the allocation request is made is not allocatable in the zeroth zone, or when MASs to be allocated exist even after the MASs for which the allocation request is made are allocated in the zeroth zone.

7. The system according to claim 1, wherein the MAC layer comprises:
an MAC application interface block for collecting the MAS allocation request provided from the MAC client; and
an MAC resource management block for calculating the number of MASs requested by the MAC client and the number of requested consecutive MASs on the basis of the collected MAS allocation request to allow the consecutive MASs to be distributed and allocated for each of the divided groups.

8. A method for allocating wireless resources in a WPAN including an MAC client layer having a plurality of MAC clients, and an MAC layer, the method comprising:
dividing, at the MAC layer, a superframe into a predetermined number of groups;
estimating, at the MAC layer, the number of MASs requested by the MAC client and the number of requested consecutive MASs when an MAS allocation request is collected from the MAC client; and
distributing and allocating, at the MAC layer, the estimated consecutive MASs for each of the divided groups.

9. The method according to claim 8, wherein the dividing, at the MAC layer, of the superframe into the predetermined number of groups comprises:
grouping a predetermined number of MASs of the superframe as one zone to allow the superframe to be divided into a predetermined number of zones on the whole; and
dividing the zones into a predetermined number of groups.

10. The method according to claim 9, wherein the dividing, at the MAC layer, of the superframe into the predetermined number of groups comprises:
dividing the superframe into sixteen zones; and
dividing the divided zones into a first group including one of the rest zones excluding a zone including a beacon period, a second group including two zones, a third group including four zones, and an fourth group including eight zones.

11. The method according to claim 8, wherein the distributing and allocating, at the MAC layer, of the estimated consecutive MASs comprises:
defining a zone of the divided zones that is included in a beacon period as a zeroth zone; and
allowing MASs for which an allocation request has been made to be allocated starting from a last MAS of the zeroth zone when the number of the MASs for which the allocation request has been made is less than the number of allocatable MASs excluding a beacon slot in the zeroth zone.

12. The method according to claim 11, wherein the distributing and allocating, at the MAC layer, of the estimated consecutive MASs comprises:
distributing and allocating MASs for which an allocation request is made by the MAC client, from a zone of the first group to a zone of the eighth group depending on the number of the requested consecutive MASs when the MASs are to be allocated in other zones excluding the zeroth zone, and beginning to allocate at a first MAS of the corresponding zone.

13. The method according to claim 12, wherein the MASs for which an allocation request is made by the MAC client are allocated in other zones excluding the zeroth zone when the number of the allocatable MASs is less than a predetermined set number and the MASs for which the allocation request is made are not allocatable in the zeroth zone, or when MASs to be allocated exist even after the MASs for which the allocation request is made are allocated in the zeroth zone.
